(19) United States
(12) Patent Application Publication
(10) Pub. No.: US 2012/0161930 A1
(43) Pub. Date: Jun. 28, 2012

(54) CROSS-READ RESOLUTION METHOD FOR USE IN A RADIO FREQUENCY IDENTIFICATION SYSTEM

(75) Inventors: PANCHAPAKESAN V. SUBRAMANIAN, Frederick, MD (US); ROBERT C. ARNESON, Baltimore, MD (US); NILAN SOLANKI, Columbia, MD (US)

(73) Assignee: SYMBOL TECHNOLOGIES, INC., Holtsville, NY (US)

(21) Appl. No.: 12/979,645

(22) Filed: Dec. 28, 2010

(51) Int. Cl. G06K 7/01

(52) U.S. Cl. 340/10.1

(57) ABSTRACT

A radio frequency identification system comprises a tag, a back-end system, and a plurality of readers, each reader having at least one antenna coupled thereto. In a cross-read resolution method performed by a first reader, the first reader receives a first tag read of the tag having a tag identifier. The first reader determines a first metric for the first tag read, and transmits the first metric and the tag identifier to a second reader. The first reader receives a second metric and the tag identifier from the second reader, wherein the second metric is determined by the second reader based on a second tag read of the tag by the second reader. The first reader executes an algorithm, based at least in part, on the first metric and the second metric, to determine whether the first reader will report the tag identifier to the back-end system.

### FIELD OF THE INVENTION

The present invention relates generally to radio frequency identification (RFID) systems and methods. More particularly, the present invention relates to a cross-read resolution method for use in an RFID system that determines which reader amongst a plurality of readers is responsible for reporting a particular tag to a back-end system.

### BACKGROUND OF THE INVENTION

Conventionally, RFID tags are electronic devices that may be affixed to items, people, animals, etc. for purpose of identification and tracking via electromagnetic waves. In a typical RFID system, an RFID reader transmits a continuous wave (CW) or modulated radio frequency (RF) signal to a RFID tag. The RFID tag receives the signal, and responds by backscattering a response to the RFID reader. The RFID reader receives the signal from the RFID tag, and the signal is demodulated, decoded and further processed.

In a physical environment comprising a plurality of RFID readers, the RFID readers may be in close physical proximity to one another. As a result, a single RFID tag may be read by more than one RFID reader, (which is called a cross-read), thus creating a challenge in associating the RFID tag to a single RFID reader, and doing so in an efficient manner. Examples of such physical environments with multiple RFID readers in close proximity include dock doors at distribution centers, point-of-sale counters at checkout lanes, and the like. Thus, in such environments, it is important to accurately identify the dock door (or the checkout lane etc.) that the item (with an affixed tag) passed through, even though RFID readers on adjacent doors (or lanes etc.) may also have read the tag. One solution currently used to overcome this challenge includes reducing the RFID reader/antenna RF power until overlaps in coverage are minimized, which in turn minimizes cross-read occurrences. This may, however, reduce read accuracy due to the reduction in RF power. Moreover, there also may be no single RF power level that is optimal for reading different types of RFID tags, while at the same time minimizing overlap between RFID readers. Another solution currently used to overcome this challenge is to have the plurality of RFID readers each report the tag to the back-end system for processing, and delegating the cross-read resolution to the back-end system. Disadvantageously, such a solution increases network traffic by redundantly reporting the tag as well as increases overall processing time for each RFID tag.

### BRIEF DESCRIPTION OF THE DRAWINGS

The present invention is illustrated and described herein with reference to the various drawings, in which like reference numbers denote like method steps and/or system components, respectively, and in which:

FIG. 1 is a diagram of an exemplary RFID system comprising a RFID tag, a plurality of RFID readers, a network and a back-end system;

FIG. 2 is a block diagram of exemplary components associated with a RFID reader;

FIG. 3 is a flowchart of a cross-read resolution method performed by a RFID reader; and

FIG. 4 is a diagram of the RFID system of FIG. 1 illustrating an exemplary read operation of the RFID tag by a plurality of RFID readers.

FIG. 5 is a flowchart of a cross-read resolution method, comprising an optional timer function, performed by a RFID reader.

### DETAILED DESCRIPTION OF THE INVENTION

In various exemplary embodiments, the present invention provides a cross-read resolution method for use in a RFID system that determines which RFID reader amongst a plurality of readers is responsible for reporting a tag identifier to the back-end system. In particular, the present invention resolves cross-reads (i.e. a read of a particular tag by two or more RFID readers) amongst a plurality of RFID readers without involving the back-end system (i.e. avoiding cross-read resolution by the back-end system), thereby reducing network traffic and making the overall back-end processing more efficient.

In one embodiment, each RFID reader that reads a tag determines a metric for the tag read, and transmits the determined metric and the tag identifier to at least one other RFID reader in the system. If the RFID reader also receives a metric for a tag read with the same tag identifier from another reader in the system, it determines a cross-read has occurred and executes an algorithm, based at least in part on the metric determined and the metric received, which determines whether the reader will report the tag identifier to the back-end system.

The process implemented to determine the metric for each tag read is substantially similar, if not identical, across a plurality of RFID readers in the system, and results in metrics that correspond to the desired tag-to-reader association. For example, the metric may be determined, at least in part, using tag read meta-data, such as, but not limited to, a received signal strength indication (RSSI), a read rate, a minimum power value, or the like. The metric may also be determined, at least in part, using the identification number of the RFID reader. The metric can be made as sophisticated as required, even incorporating business logic, if desired. Thus, based on the design of the system, the metric for each tag read may be determined by the RFID reader in a variety of ways, which will become obvious to a person of skill in the art in view of the present invention. It should be noted that a metric is determined by each RFID reader via its processor, transceiver, or combination thereof.

Moreover, the algorithm executed to determine whether the RFID reader will report the tag identifier to the back-end system is also substantially similar, if not identical, across a plurality of RFID readers in the system. Having each RFID reader that reads the same tag execute a substantially similar algorithm to determine whether it will report the tag identifier to the back-end system mitigates the likelihood that more than one RFID reader will report the same tag identifier to the back-end system. Thus, it is important to note, that unlike traditional systems, the RFID readers are not configured to automatically report every tag identifier they read to the back-end system. The present invention requires each RFID reader to execute a cross-read resolution algorithm to determine whether it should report a particular tag identifier to the back-end system, or remain quiet, when the RFID reader detects a cross-read. Let us now refer to the figures to describe the present invention in greater detail.

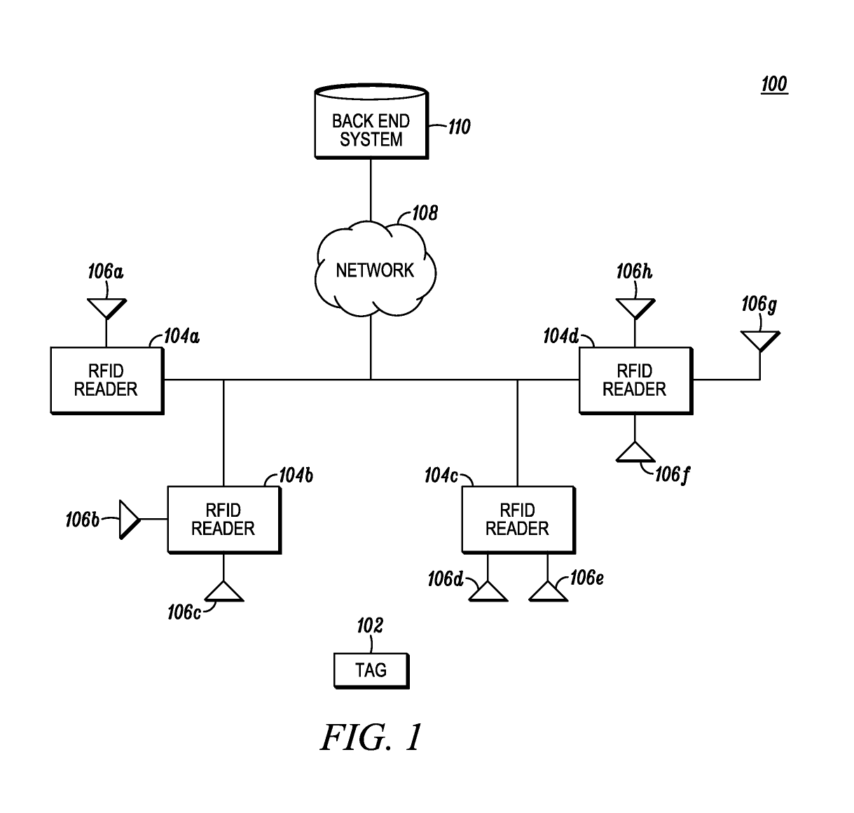

Referring to FIG. 1, an exemplary RFID system 100 is illustrated. The RFID system 100 may be deployed in any type of physical environment, such as a warehouse, distribution center, point-of-sale counters, etc. The RFID system 100 comprises a RFID tag 102 and a plurality of RFID readers 104. Each of the RFID readers 104 is coupled to one or more antennas 106 for RF communication with the RFID tag 102. In this example, the RFID system 100 comprises four RFID readers 104a-104d: RFID reader 104a is coupled to antenna 106a; RFID reader 104b is coupled to antennas 106b and 106c; RFID reader 104c is coupled to antennas 106d and 106e; and RFID reader 104d is coupled to antennas 106f, 106g and 106h. It is important to note that an antenna 106 may be physically located within the RFID reader 104 or physically separate and coupled to the RFID reader 104 (e.g. via a wired or wireless connection).

In this example, the RFID system 100 further comprises a network 108 and a back-end system 110. The RFID readers 104 are communicatively coupled, via the network 108, to the back-end system 110 (e.g. a server, a computer, or the like). Further, the RFID readers 104 may be communicatively coupled to one another via the network 108, or via another network that is different from network 108, and may be collectively referred to as a reader network. It should be noted that although the exemplary embodiment of FIG. 1 illustrates a single RFID tag 102, four RFID readers 104 and eight antennas 106, those of ordinary skill in the art will immediately recognize that any number of RFID tags 102, RFID readers 104, antennas 106, networks 108 and back-end systems 110 may be utilized in the RFID system 100.

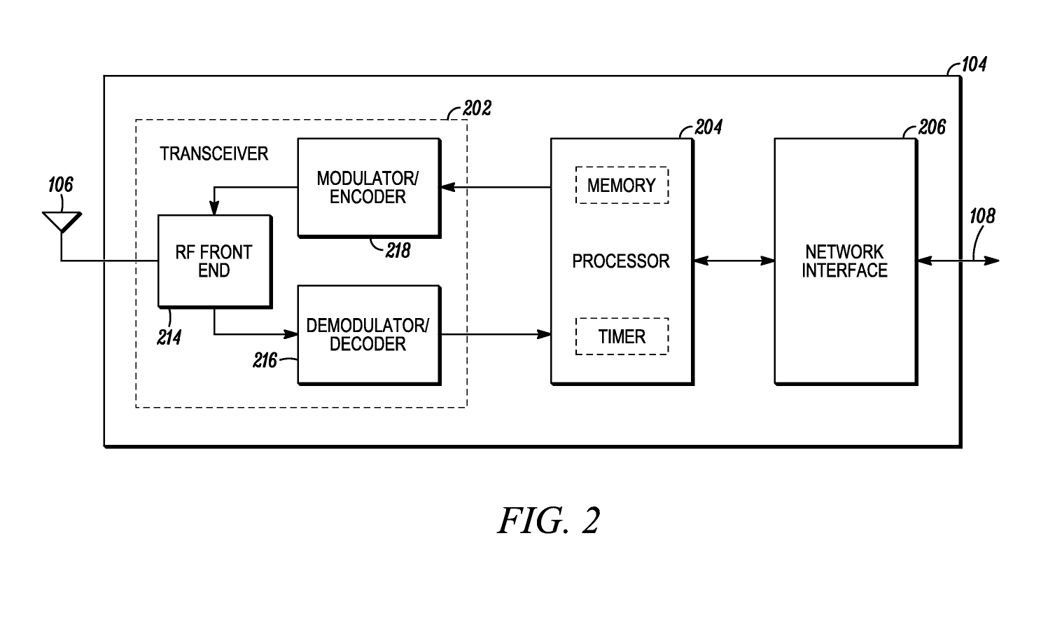

Referring to FIG. 2, in an exemplary embodiment, a block diagram illustrates the RFID reader 104. Specifically, the RFID reader 104 comprises one or more antennas 106, a transceiver 202, a processor 204 coupled to the transceiver 202, and a network interface 206 coupled to the processor 204. It should be appreciated that FIG. 2 depicts the RFID reader 104 in an oversimplified manner and a practical embodiment of the RFID reader 104 may include additional components and suitably configured processing logic to support known or conventional operating features that are not described in detail herein. In general, the RFID reader 104 includes software, hardware, and/or firmware, or any combination thereof, for performing functions associated with the RFID reader 104, such as communicating with RFID tags 102 through its antenna 106. Specifically, each of the RFID readers 104 is capable of transmitting an interrogation signal, and receiving a tag response signal that can be decoded to derive tag data. As noted above, at least one antenna 106 may be integrated within the RFID reader 104, such as in a same housing, or may be external from the RFID reader 104 and coupled to the transceiver 202. The present invention contemplates any type of antenna known to those of ordinary skill in the art, such as, but not limited to, vertical, dipole, loop, Yagi-Uda, slot, or patch antenna types.

The RFID reader 104 typically operates in one or more of the frequency bands allotted for this type of RF communication, e.g. frequency bands of 902-928 MHz and 2400-2483.5 MHz have been defined for certain RFID applications by the Federal Communication Commission (FCC). A variety of mechanisms may be used to initiate an interrogation signal by the RFID reader 104. For example, an interrogation signal may be initiated by a remote computer system/server, i.e. the back-end system 110, which communicates with the RFID reader 104 over the network 108. Alternatively, the RFID reader 104 may include a finger-trigger mechanism, a keyboard, a graphical user interface (GUI), a voice activated mechanism, a motion sensor, a photo-eye, or the like to initiate the interrogation signal by the RFID reader 104.

The configuration of the transceiver 202 shown in FIG. 2 is provided for purposes of illustration only, and is not intended to be limiting. The transceiver 202 may be configured in numerous ways to modulate, transmit, receive, and demodulate RFID communication signals, as would be known to those of ordinary skill in the art. The transceiver 202 includes circuitry and other electronics to interface between wireless over-the-air communications and digital communications with the processor 204. Specifically, the transceiver 202 typically comprises a RF front-end 214, a demodulator/decoder 216, and a modulator/encoder 218, which may include software, hardware, and/or firmware, or any combination thereof, for performing associated functions. The demodulator/decoder 216 and the modulator/encoder 218 are communicatively coupled to the processor 204. For example, the modulator/encoder 218 may receive an interrogation signal from the processor 204, and the modulator/encoder 218 is coupled to an input of the RF front-end 214. The modulator/encoder 218 encodes the interrogation signal into a signal format, modulates the encoded signal, and outputs the modulated encoded interrogation signal to the RF front-end 214. For example, in embodiments, such as in, but not limited to, the electronic product code (EPC) Gen 2 protocol environment, pulse-interval encoding (PIE), double sideband amplitude shift keying (DSB-ASK), single sideband amplitude shift keying (SSB-ASK), or phase-reversal amplitude shift keying (PR-ASK) modulation schemes may be used.

The RF front-end 214 may include one or more antenna matching elements, amplifiers, filters, an echo-cancellation unit, a down-converter, and/or an up-converter. The RF front-end 214 receives a modulated encoded interrogation signal from the modulator/encoder 218, up-converts the interrogation signal, if necessary, and transmits the interrogation signal to one of the antennas 106 to be radiated. Furthermore, in the opposite direction, the RF front-end 214 receives a tag response signal through one of the antennas 106 and down-converts the response signal to a frequency range amenable to further signal processing, if necessary.

The demodulator/decoder 216 is coupled to an output of the RF front-end 214 and receives the modulated tag response signal from the RF front-end 214. In an EPC Gen 2 protocol environment, for example, the received modulated tag response signal may have been modulated according to amplitude shift keying (ASK) or phase shift keying (PSK) modulation techniques. The demodulator/decoder 216 demodulates the tag response signal, which, for example, may include backscattered data formatted according to FM0 or Miller encoding formats. The demodulator/decoder 216 outputs a decoded data signal to the processor 204.

The processor 204 can be any microprocessor, application specific integrated circuit (ASIC), field programmable gate array (FPGA), digital signal processor (DSP), any suitable programmable logic device, discrete gate or transistor logic, discrete hardware components, or combinations thereof that has the computing power capable of managing the transceiver 202, the antenna 106, and the network interface 206. Further, the processor 204 may include volatile memory (e.g. random access memory (RAM), such as dynamic random access memory (DRAM), static random access memory (SRAM), synchronized dynamic random access memory (SDRAM), etc.)), nonvolatile memory (e.g. read only memory (ROM), hard drive, tape, compact disc read only memory (CD-ROM), etc.), and combinations thereof. The memory may be a part of or separate from the processor 204. The software stored in the memory may include one or more applications, each of which includes an ordered listing of executable instructions for implementing logical functions. The processor 204, with its associated memory, generally represents the hardware, software, firmware, processing logic, and/or other components of the RFID reader 104 that enables communication between the RFID reader 104 and the RFID tags, other RFID readers, and other network components to which the RFID reader 104 communicates. The processor 204 is configured to execute software instructions and algorithms stored within the memory, to communicate data to and from the memory, and to generally control the operations of the RFID reader 104 pursuant to the software instructions. In particular, the cross-read resolution algorithm of the present invention is stored in the memory. The processor 204 may also provide the interrogation signal to the transceiver 202, and may receive a decoded data signal from the transceiver 202 that was generated from the tag response. It should be noted that in an alternative embodiment, the processor 204 may perform the encoding functions of the modulator/encoder 218 and/or the decoding function of the demodulator/decoder 216. It should also be noted that the processor 204 may be present in the RFID reader 104, or may be located remote from the RFID reader 104.

The network interface 206 may be used to enable the RFID reader 104 to communicate on the network 108. The network interface 206 may include, for example, an Ethernet card (e.g. 10BaseT, Fast Ethernet, Gigabit Ethernet) or a wireless local area network (WLAN) card (e.g. 802.11a/b/g). The network interface 206 may include address, control, and/or data connections to enable appropriate communications on the network. Also, the network interface 206 may include a wireless antenna for communication over a service provider network. The network interface 206 may be used to transmit the decoded data signal received from the transceiver 202 (or optionally through the processor 204) to the back-end system 110 coupled to the network 108. It should be noted that in some embodiments, the network interface 206 may be used to receive the interrogation signal, for example, from a remote computer system or server, such as the back-end system 110, or the like. Thus, the network interface 206 may be used to enable the RFID reader 104 to communicate on the network 108 to the back-end system 110: if the processor 204 resides remotely from the RFID reader 104, the network interface 206 may be used to communicate between the transceiver 202 and a remote server 110, which could include the processor 204; if the processor 204 resides within the RFID reader 104, the network interface 206 may be used to communicate between the processor 204 and the remote server 110.

The RFID tag 102 is configured to backscatter one or more tag response signals in response to receiving an interrogation signal from a RFID reader 104. If within the coverage area of the RFID tag, the RFID reader 104 is configured to receive one or more response signals from the RFID tag via their respective antenna(s) 106, and to obtain associated data related to the RFID tag 102 from the one or more response signals. It should be noted that the RFID tag 102 and the RFID readers 104 may be capable of communicating according to any suitable communication protocol, including Class 0, Class 1, EPC Gen 2, other binary traversal protocols and slotted ALOHA protocols, any other protocols mentioned elsewhere herein, future communication protocols, etc.

The back-end system 110 may be a digital computer that, in terms of hardware architecture, generally includes a processor, input/output (I/O) interfaces, network interfaces, memory, and a data and file storage. When the back-end system 110 is in operation, the processor is configured to execute software stored within the memory, to communicate data to and from the memory, and to generally control operations of the back-end system 110 pursuant to the software instructions. In an exemplary embodiment, the back-end system 110 is generally configured to receive data from the RFID readers 104 and perform further processing thereon. For example, the back-end system 110 may include an inventory processing system, a point-of-sale checkout server, etc.

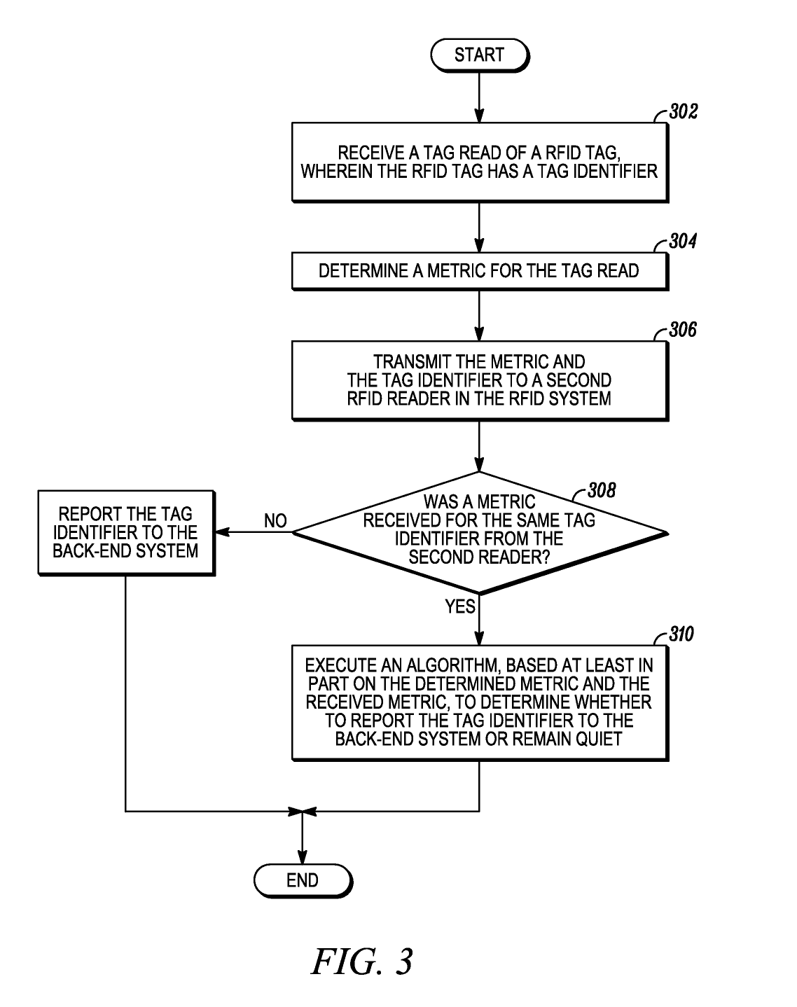

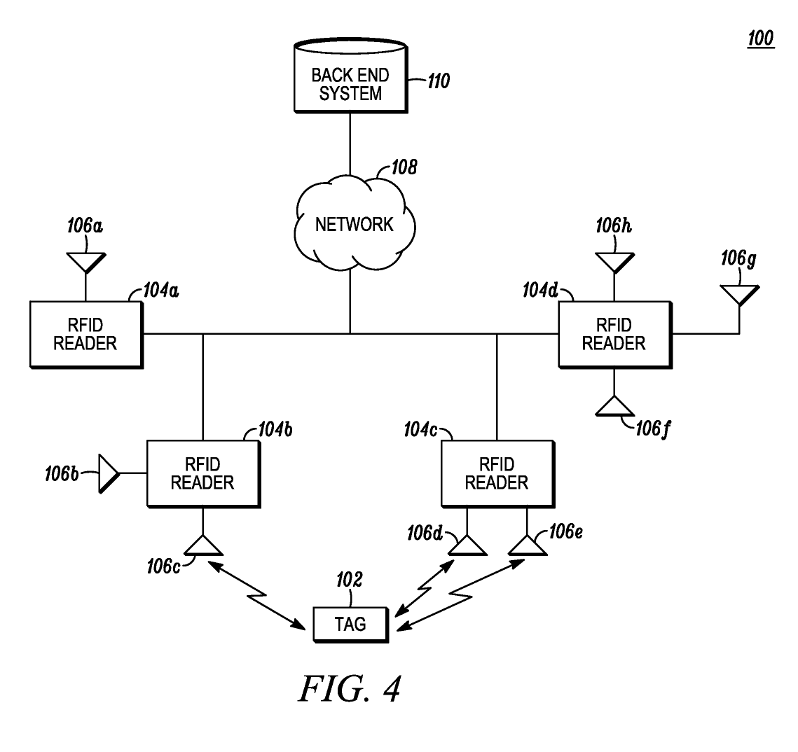

Let us turn our attention to some examples of operation by first referring to FIGS. 3 and 4. FIG. 3 illustrates a flowchart of an exemplary operation of a cross-read resolution method performed by a RFID reader 104 in a RFID system, and FIG. 4 is a diagram of the RFID system illustrating an exemplary read operation of the RFID tag by a first RFID reader and a second RFID reader. The RFID system comprises a RFID tag, a back-end system, and a plurality of RFID readers. Each RFID tag has a tag identifier, and each RFID reader has at least one antenna coupled thereto. In operation, when a first RFID reader receives a tag read of a RFID tag (at step 302), the first RFID reader determines a first metric for the tag read (at step 304). Once the metric is determined, the first RFID reader transmits, via broadcast, multicast, or unicast, the first metric and the tag identifier for the RFID tag to a second RFID reader in the RFID system (at step 306). Transmitting the metric and the tag identifier to a RFID reader in the system may be performed over a local network, an over-the-air interface, or by any other appropriate means. In this example, the first RFID reader also receives a second metric for the same tag identifier from the second RFID reader (at step 308). The second metric is determined by the second RFID reader based on a tag read of the RFID tag by the second RFID reader. It should be noted that the first RFID reader could receive the second metric from the second RFID reader before it receives its own tag read of the RFID tag and/or before it is able to determine the first metric. Since the first RFID received a metric from another RFID reader for the same tag identifier that it read, the first RFID reader executes an algorithm, based at least in part on the first metric and the second metric, to determine whether the first RFID reader will report the RFID tag identifier to the back-end system (at step 310). It should be noted that if the first RFID reader did not receive the second metric for the same tag identifier from the second RFID reader, the first RFID reader would not have executed the algorithm (at step 310), but rather would have reported the tag identifier to the back-end system (at step 312) since it believed it was the only RFID reader that read the tag (i.e. the first RFID reader did not detect that a cross-read occurred).

As noted above, the process implemented by the first RFID reader to determine the first metric for its tag read is substantially similar, if not identical, to the process implemented by the second RFID reader to determine the second metric for its tag read. Examples of such a metric include, but are not limited to, the number of times the RFID tag was read in the last N seconds across all antennas connected to a RFID reader, the most recent value of RSSI reported separately for each antenna (i.e. the last RSSI value associated with the last tag read), the highest value of RSSI in the last N seconds, the average value of RSSI in the last N seconds, the highest number of distinct antennas (coupled to the same RFID reader) that have read the RFID tag at least once, the highest number of other RFID tags previously read by the RFID reader, highest or lowest RFID reader identification number, the RFID reader that read the RFID tag the earliest, the RFID reader that read the RFID tag the latest, or the like. The metric may be anything that differentiates the RFID readers from one another. It is important to note that the present invention uses the metric, at least in part, to determine which RFID reader is the designated reader to report the tag identifier to the back-end system in a cross-read scenario.

Moreover, in some embodiments as noted above, the algorithm executed by the first RFID reader to determine whether the first RFID reader will report the tag identifier to the back-end system is substantially similar, or identical, to an algorithm executed by the second RFID reader to determine whether the second RFID reader will report the tag identifier to the back-end system. The result of the algorithm executed by at least the first and second RFID readers may simply inform each reader executing the algorithm whether or not it will report the tag identifier to the back-end system, specifically identify which RFID reader in the network will report the tag identifier to the back-end system, or the like. For example, let us assume the metric determined by the RFID readers is the highest number of times the RFID tag was read by each RFID reader. Referring to FIG. 4, let us also assume that the first RFID reader 104b read the RFID tag fifty times and the second RFID reader 104c read the RFID tag seventy-five times. The first RFID reader 104b transmits to the second RFID reader 104c that it read a particular tag fifty times. Similarly, the second RFID reader 104c transmits to the first RFID reader 104b that it read the same tag seventy-five times. When the first RFID reader 104b executes the algorithm, based at least in part on the metric it determined and the metric determined by the second RFID reader 104c, it will determine that it will not report the tag identifier to the back-end system, and acts accordingly (i.e. the first RFID reader 104b may be quiet about its reading of the RFID tag). However, when the second RFID reader 104c executes the algorithm, based at least in part on the metric it determined and the metric determined by the first RFID reader 104b, it will determine that it will report the tag identifier to the back-end system, and acts accordingly. In yet another example, let us assume that the metric used by the plurality of RFID readers is now the highest number of distinct antennas coupled to a RFID reader that have read the RFID tag at least once. In this example, the first RFID reader 104b would determine that it would not need to report the tag identifier to the back-end system after executing the algorithm since only one of its antennas, 106c, read the tag, whereas the second RFID reader 104c would determine that it would report the tag identifier to the back-end system after executing the algorithm since both of its antennas, 106d and 106e, read the tag.

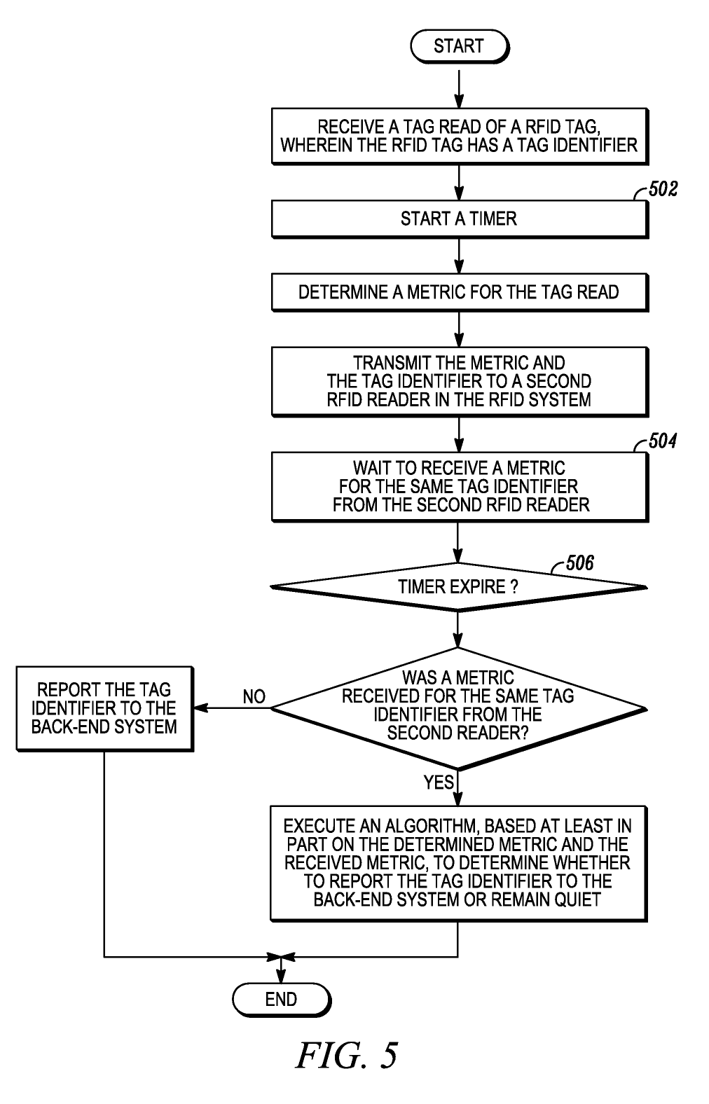

Further, in some embodiments, as illustrated in FIG. 5, the RFID readers may comprise a timer, or a timer function may be implemented in the processor in order to better determine if a cross-read has occurred. In these embodiments, the first RFID reader may start a timer (at step 502) for a predetermined time window (e.g. 50 ms, 500 ms, etc.) prior to executing the algorithm that is used to determine whether the first RFID reader will report the tag identifier to the back-end system. In the example illustrated in FIG. 5, the first RFID reader sets the timer after it receives the tag read of the RFID tag, however, the system may be designed such that the RFID reader sets the timer for the predetermined time window after it determines the metric for the tag read, after it transmits the metric to another RFID reader, after it sends or detects an interrogation signal being sent from another RFID reader, or the like (such as in response to a motion sensor or photo-eye). Thus, in the embodiments in which the timer is implemented, the first RFID reader waits to receive a metric for the same tag identifier from the second RFID reader (at step 504) until the timer expires (at step 506). If, upon expiration of the timer, the RFID reader does not receive a metric from another RFID reader relating to the tag identifier, it can assume that a cross-read did not occur, and may proceed with reporting the tag identifier to the back-end system as usual. If, however, the RFID reader did receive a metric for the same tag identifier prior to the expiration of the timer, the RFID reader determines that a cross-read occurred, and executes the appropriate algorithm, based at least in part on the determined metric and the received metric, to determine if it will report the tag identifier to the back-end system, or remain quiet.

In an exemplary embodiment, RFID readers may also be configured to transmit a timestamp of the tag read and time window. This enables the RFID readers to know how long they have to transmit their metric for the same tag read. Having knowledge of the timestamps and time windows allows each RFID reader to determine if there is a cross-read. For example, a read of the same RFID tag outside of the time window may not be considered a cross-read. Moreover, the timestamp becomes more important if the metric is, for example, the identifier of the RFID reader that read the RFID tag the earliest or the latest. Thus, waiting to execute the algorithm that determines whether it will report the tag identifier to the back-end system allows the RFID reader adequate time to receive metrics relating to tag reads of the same RFID tag performed by other RFID readers in the system prior to determining whether it will or will not report the tag identifier to the back-end system. In other words, implementation of the timer is advantageous to prevent a RFID reader from prematurely determining whether it should or should not report the tag identifier to the back-end system.

To add a twist to the example above, let us assume that the first RFID reader has two antennas coupled to it and both antennas performed a tag read on the RFID tag. In some embodiments, the first RFID reader receives a third tag read of the RFID tag by the second antenna coupled to it, and determines a third metric for the third tag read. The first RFID reader also transmits the third metric and tag identifier to the second RFID reader, and when it executes the algorithm, the algorithm is based, at least in part, on the first metric, the second metric and the third metric. It is important to note that throughout the description, the designation of first, second, and third does not imply a sequential order, but rather merely distinguishes one element from another in the order in which they are presented in the description.

In other embodiments, the first RFID reader receives a tag read of the RFID tag by the second antenna coupled to it, and determines a metric for the tag read. Instead of transmitting each metric for each tag read to the second RFID reader, the first RFID reader may take an average of its plurality of tag reads and transmit the average metric to the second RFID reader. Alternatively, the first RFID reader may take the best metric determined from the plurality of tag reads, and transmit the best metric to the second RFID reader.

In some embodiments, a relationship may be known or determined by the plurality of RFID readers, and the relationship may be utilized by each of the plurality of RFID readers when transmitting their metrics. Thus, the transmission of the metric and tag identifier may be constrained based on the relationship between the plurality of RFID readers. In other words, transmitting the metric and tag identifier at each of the plurality of RFID readers based on the relationship may include a RFID reader transmitting its metric only to other RFID readers with overlapping coverage, or transmitting its metric only to other RFID readers that are physically adjacent or within a predetermined distance of each other, in order to reduce the network traffic. For example, the RFID readers in a reader network may have a location awareness of each other such that they know which RFID readers are adjacent or physically proximate to one another where cross-reads are more likely to occur. In these cases, communication on the reader network may be constrained based upon location, e.g. adjacent RFID readers may communicate only with N other adjacent RFID readers (N being an integer), wherein transmitting the determined metric and tag identifier includes transmitting a message to only those RFID readers that meet the criteria of the relationship.

With respect to concerns that a reader network (e.g. network 108, or other networks that communicative couple the RFID readers 104) will be flooded with RFID readers 104 reporting their reads, metrics, timestamps, etc. (collectively referred to as “negotiation” or “negotiating”), the present invention contemplates several aspects with respect to configuring the reader network. In an exemplary embodiment, negotiation does not need to be done over the network 108; it could be done over-the-air via the antennas 106. For example, the RFID readers 104 may be configured to transmit their reads, metrics, timestamps, etc. via RF messages to RFID readers 104 with overlapping coverage (in addition to interrogating the RFID tag 102 via the antennas 106). Here, as described herein, the RFID readers 104 only need to communicate with other physically proximate RFID readers, thereby reducing the overall network traffic. For example, the RFID reader 104a may be configured to negotiate only with the RFID reader 104b, RFID reader 104b may be configured to negotiate only with RFID readers 104a and 104c, and RFID reader 104c may be configured to negotiate only with RFID readers 104b and 104d. This example assumes that the coverage of the RFID readers do not extend beyond the adjacent RFID reader. Further, in this exemplary embodiment, the present invention contemplates that RFID readers in a single physical location are expected to be on the same network subnet, and the network traffic due to negotiation is thereby limited to this small portion of the overall network 108. For example, RFID readers 104 can be reliably expected to be on a same subnet or switch of the overall network 108 thereby localizing the negotiation traffic.

In another exemplary embodiment, the reader network may be constrained with respect to the negotiations between the RFID readers 104. In this exemplary embodiment, a user or operator may be able to manually configure which of the RFID readers 104 negotiate there between. For example, the RFID reader 104a may be configured to negotiate with the RFID readers 104b, 104c, but not with the RFID reader 104d. In yet another exemplary embodiment, the RFID readers 104 may be configured to subscribe to physically proximate RFID readers 104 or RFID readers with overlapping coverage to form the reader network. Here, the RFID readers 104 communicate with one another for status, and/or other information, and may realize, based on their communications, that there is a possibility of cross-reads. As such, they configure one another to negotiate on the reader network. In other words, the reader network may be formed arbitrarily by the RFID readers 104 without manual input or instructions from the back-end system 110. The RFID readers 104 may be aware of RFID readers 104 with overlapping coverage and designate a master RFID reader 104 with subsequent slave RFID readers 104 for purposes of forming the reader network.

Thus, the present invention contemplates use with any array or deployment of a plurality of RFID readers where possible cross-reads may occur. Advantageously, the present invention allows the RFID readers to operate at a desired RF strength (or any other required RF strength) without having to reduce RF overlap. Using the methods of the present invention, cross-reads are mitigated using peer-to-peer adjudication by the RFID readers without requiring the participation of the back-end system 110 for cross-read resolution. In exemplary applications, the present invention may speed up processing of RFID tags in a warehouse environment, point-of-sale counters, and the like.

Although the present invention has been illustrated and described herein with reference to various embodiments and specific examples thereof, it will be readily apparent to those of ordinary skill in the art, after review of the present invention, which other embodiments and examples may perform similar functions and/or achieve like results. All such equivalent embodiments and examples are within the spirit and scope of the present invention and are intended to be covered by the following claims.

What is claimed is:

1. In a radio frequency identification (RFID) system comprising a RFID tag, a back-end system, and a plurality of RFID readers, each RFID reader having at least one antenna coupled thereto, a cross-read resolution method for the RFID system, comprising, by a first RFID reader:
receiving a first tag read of the RFID tag, wherein the RFID tag has a tag identifier;
determining a first metric for the first tag read;
transmitting the first metric and the tag identifier to a second RFID reader;
receiving a second metric and the tag identifier from the second RFID reader, wherein the second metric is determined by the second RFID reader based on a second tag read of the RFID tag by the second RFID reader; and
executing an algorithm, based at least in part on the first metric and the second metric, to determine whether the first RFID reader will report the tag identifier to the back-end system.

2. The method of claim 1, wherein the second RFID reader determined the second metric for the second tag read in a substantially similar manner in which the first RFID reader determined the first metric for the first tag read.

3. The method of claim 1, wherein the first metric is determined, at least in part, based on metadata of the RFID tag.

4. The method of claim 1, wherein the first metric is determined, at least in part, by one of the following: a received signal strength indicator, a read rate value, a minimum power value, a number of times the RFID tag was read in the last N seconds, a highest value of RSSI in the last N seconds, an average value of RSSI in the last N seconds, a number of distinct antennas coupled to the first RFID reader that have read the RFID tag at least once, a number of other RFID tags previously read, an identification number of the first RFID reader, whether the first RFID reader read the RFID tag the earliest, or whether the first RFID reader read the RFID tag the lastest.

5. The method of claim 1, wherein the second RFID reader executes a substantially similar algorithm as the first RFID reader, based at least in part, on the first metric and the second metric, to determine whether the second RFID reader will report the tag identifier to the back-end system.

6. The method of claim 1, further comprising starting a timer for a predetermined time period after receiving the first tag read, and wherein the second metric was received prior to expiration of the timer, and wherein executing the algorithm is performed upon expiration of the timer.

7. The method of claim 6, further comprising transmitting a timestamp to the second RFID reader based on one of the following occurrences: a time in which the first RFID reader performed the first tag read, a time in which the first RFID reader determined the first metric, or a time in which the first RFID reader transmitted the first metric.

8. The method of claim 6, further comprising receiving a time stamp from the second RFID reader based on one of the following occurrences: a time in which the second RFID reader performed the second tag read, a time in which the second RFID reader determined the second metric, or a time in which the second RFID reader transmitted the second metric.

9. The method of claim 1, wherein transmitting the first metric to the second RFID reader is performed over a local network or an over-the-air interface.

10. The method of claim 1, further comprising:
receiving a third tag read of the RFID tag;
determining a third metric for the third tag read, and
transmitting the third metric and the tag identifier to the second RFID reader,
wherein executing the algorithm is based, at least in part, on the first metric, the second metric and the third metric.

11. The method of claim 1, wherein transmitting the first metric to the second RFID reader is based on satisfying a relationship criteria for the first RFID reader in relation to the second RFID reader.

12. The method of claim 11, wherein the relationship criteria is at least one of the following: overlapping radio frequency coverage of the first RFID reader and the second RFID reader, a predetermined physical distance between the first RFID reader and the second RFID reader, or a likelihood of a cross-read occurrence between the first RFID reader and the second RFID reader.

13. The method of claim 1, further comprising discarding or storing the tag identifier without reporting the tag identifier to the back-end system if it is determined that the first RFID reader will not report the tag identifier to the back-end system.

14. A reader used for resolving cross-reads in a radio frequency identification (RFID system, the reader comprising;
a transceiver;
a processor, coupled to the transceiver; and
a network interface, coupled to the processor,
wherein the reader performs the following functions:
receiving a first tag read of the RFID tag, wherein the RFID tag has a tag identifier;
determining a first metric for the first tag read;
transmitting the first metric and the tag identifier to a second RFID reader;
receiving a second metric and the tag identifier from the second RFID reader, wherein the second metric is determined by the second RFID reader based on a second tag read of the RFID tag by the second RFID reader; and
executing an algorithm, based at least in part on the first metric and the second metric, to determine whether the first RFID reader will report the tag identifier to the back-end system.

15. The reader of claim 14, further comprising a timer, coupled or integral to the processor, wherein the first RFID reader starts the timer for a predetermined time period after receiving the first tag read, wherein the second metric was received prior to an expiration of the timer, and wherein the algorithm is executed upon expiration of the timer.

16. The reader of claim 14, wherein the first metric and the second metric are determined by the first RFID reader and the second RFID reader, respectively, at least in part, based on metadata of the RFID tag.

17. A radio frequency identification (RFID) system used to resolve cross-reads, comprising:
a plurality of RFID readers, each RFID reader having at least one antenna coupled thereto, a processor, a transceiver and a memory;
a back-end system communicatively coupled to the plurality of RFID readers; and
a RFID tag,
wherein a first RFID reader receives a first tag read of the RFID tag having a tag identifier, determines a first metric for the first tag read, transmits the first metric and the tag identifier to a second RFID reader, receives a second metric and the tag identifier from the second RFID reader, and executes a first algorithm, based at least in part, on the first metric and the second metric, to determine whether the first RFID reader will report the tag identifier to the back-end system,
wherein the second RFID reader receives a second tag read of the RFID tag having the tag identifier, determines the second metric for the second tag read, transmits the second metric and the tag identifier to the first RFID reader, receives the first metric and the tag identifier from the first RFID reader, and executes a second algorithm, based at least in part, on the first metric and the second metric, to determine whether the second RFID reader will report the tag identifier to the back-end system, and
wherein the first algorithm and the second algorithm are substantial similar.

18. The system of claim 17, wherein the first RFID reader receives a third tag read of the RFID tag, determines a third metric for the third tag read, and transmits the third metric and the tag identifier to the second RFID reader, and executes the first algorithm, based at least in part, on the first metric, the second metric and the third metric, to determine whether the first RFID reader will report the tag identifier to the back-end system, and
wherein the second RFID reader receives the third metric and the tag identifier from the first RFID reader, and executes the second algorithm, based at least in part, on the first metric, the second metric, and the third metric, to determine whether the second RFID reader will report the tag identifier to the back-end system.

19. The system of claim 17, wherein the first RFID reader further comprises a first timer, and the second RFID reader further comprises a second timer;
wherein the first RFID reader starts the first timer for a first predetermined time period after receiving the first tag read, wherein the second metric was received prior to an expiration of the timer, and wherein the first algorithm is executed upon expiration of the first timer;
wherein the second RFID reader starts the second timer for a second predetermined time period after receiving the second tag read, wherein the first metric was received prior to an expiration of the second timer, and wherein the second algorithm is executed upon expiration of the second timer.

20. The system of claim 17, wherein the first metric and the second metric are determined by the first RFID reader and the second RFID reader, respectively, at least in part, based on metadata of the RFID tag.
